(19) United States
(12) Patent Application Publication
(10) Pub. No.: US 2021/0086957 A1
(43) Pub. Date: Mar. 25, 2021

(54) BIO-DEGRADABLE FOOD CONTAINER

(71) Applicant: Reflect Earth LLC, Charlotte, NC (US)

(72) Inventor: David William KADE, Charlotte, NC (US)

(21) Appl. No.: 16/580,080

(22) Filed: Sep. 24, 2019

(51) Int. Cl. B65D 43/12; B65D 65/46; B65D 25/04

(52) U.S. Cl. CPC B65D 43/12; B65D 2543/00842; B65D 25/04; B65D 65/466

(57) ABSTRACT

A bio-degradable container that includes a bottom portion, and a top portion. A extends outwardly from the bottom portion and contains a notch on the top portion of the first tab. A second tab extends outwardly from the top portion and contains a slot having a correspondingly similar shape to the notch of the first tab. At least one channel is disposed within the top portion, and at least one rib is disposed on the bottom portion. The notch of the first tab is received within the slot of the second tab and the rib is received within the channel of the top portion for forming a selectively secured arrangement between the bottom portion and the top portion when the top portion is placed over the bottom portion.

### FIELD OF THE INVENTION

The present invention relates generally to a biodegradable food container and more generally relates to a biodegradable food container with a top portion that is selectively secured to the bottom portion for preventing the contents of the container from spilling out.

### BACKGROUND OF THE INVENTION

Many food containers designed for take-out food are composed of plastics or Styrofoam, such as polystyrene. Polystyrene food packaging has two forms—rigid and foam. Polystyrene does not biodegrade, instead it fractures into small pieces, commonly known as microplastics. Microplastics have been found in the depths of the ocean, animals, and in the food supply. Additionally, polystyrene takes up much needed space in landfills and can be harmful to the environment.

There is a need for a food container that is rigid enough to carry food items that contains a locking lid for preventing spills and messes but is also environmentally friendly. It is an object of the present invention to provide an environmentally friendly food container that will not harm the environment and can break down in its constituent parts after use, while at the same time, being sturdy and containing a locking lid to prevent spills and messes.

### BRIEF SUMMARY OF THE INVENTION

According to an embodiment of the present invention a bio-degradable container includes a bottom portion and a top portion. A first tab, having a top portion and a bottom portion, extends outwardly from the bottom portion and contains a notch on the top portion of the first tab. A second tab, having a top portion and a bottom portion, extends outwardly from the top portion and contains a slot having a correspondingly similar shape to the notch of the first tab. The notch of the first tab is received within the slot of the second tab when the top portion is placed over the bottom portion forming a selectively secured arrangement between the bottom portion and the top portion.

According to yet another embodiment of the present invention, the bio-degradable container includes a base portion, a first pair of opposed sidewalls and a second pair of opposed sidewalls that intersect each other. The first pair of opposed sidewalls and the second pair of opposed sidewalls extend upwards to an upper edge. A lip extends outwardly from the first pair of opposed sidewalls and the second pair of opposed sidewalls of the bottom portion.

According to yet another embodiment of the present invention, the bio-degradable container includes a top portion that has a top side and a bottom side, the bottom side contains a track.

According to yet another embodiment of the present invention, the bio-degradable container includes a bottom portion that has a base portion, a first pair of opposed sidewalls, and a second pair of opposed sidewalls that intersect each other and form a cavity therein. The first pair of opposed sidewalls and the second pair of opposed sidewalls extend upwards to an upper edge and a lip extends outwardly from the first pair of opposed sidewalls and the second pair of opposed sidewalls of the bottom portion. The top portion contains a top side and a bottom side, the bottom side contains a track for receiving the lip of the bottom portion for forming the selectively secured arrangement between the top portion and the bottom portion.

According to yet another embodiment of the present invention, the bio-degradable container is composed of pulp material.

According to yet another embodiment of the present invention, the bio-degradable container is composed of sugarcane bagasse.

According to yet another embodiment of the present invention, the bio-degradable container includes a notch that has a top portion and four side portions.

According to yet another embodiment of the present invention, a bio-degradable container includes a bottom portion, a top portion having a top side and a bottom side, and at least one channel is disposed within the top portion. At least one rib is disposed on the bottom portion that is received within the channel of the top portion for forming a selectively secured arrangement between the bottom portion and the top portion.

According to yet another embodiment of the present invention, the bio-degradable container includes a channel that extends from the top side to the bottom side of the top portion.

According to yet another embodiment of the present invention, the bio-degradable container includes a channel and a rib that have corresponding shapes.

According to yet another embodiment of the present invention, the bio-degradable container includes at least one cavity within the bottom portion.

According to yet another embodiment of the present invention, the bio-degradable container includes two or more cavities within the bottom portion.

According to yet another embodiment of the present invention, the bio-degradable container includes a first tab having a top portion and a bottom portion, the first tab extends outwardly from the bottom portion and contains a notch on the top portion of the first tab. A second tab has a top portion and a bottom portion, the second tab extends outwardly from the top portion and contains a slot having a correspondingly similar shape to the notch of the first tab. The notch of the first tab is received within the slot of the second tab when the top portion is placed over the bottom portion

According to yet another embodiment of the present invention, the bio-degradable container includes a bottom portion, and a top portion having a top side and a bottom side. A first tab has a top portion and a bottom portion, the first tab extends outwardly from the bottom portion and contains a notch on the top portion of the first tab. A second tab has a top portion and a bottom portion, the second tab extends outwardly from the top portion and contains a slot having a correspondingly similar shape to the notch of the first tab. At least one channel is disposed within the top portion, and at least one rib disposed on the bottom portion. The notch of the first tab is received within the slot of the second tab and the rib is received within the channel of the top portion for forming a selectively secured arrangement between the bottom portion and the top portion when the top portion is placed over the bottom portion.

According to yet another embodiment of the present invention, the bio-degradable container includes three compartments.

### BRIEF DESCRIPTION OF THE DRAWINGS

The present invention is illustrated and described herein with reference to the various drawings, in which like reference numbers denote like method steps and/or system components, respectively, and in which:

FIG. 1 is a perspective view of the container;

FIG. 2 is a perspective view of the top portion being engaged to the bottom portion of the container;

FIG. 3 is a perspective view of the top portion and the bottom portion containing a detail of the rib of the bottom portion and the channel of the top portion of the container;

FIG. 4a is a side view of the container along line 4 of FIG. 1 showing the notch of the bottom portion engaged to the slot of the top portion;

FIG. 4b is a side view of the container indicating how the notch is received within the slot;

FIG. 5 is a perspective cut-away view of the container along line 5 in FIG. 1 showing the rib engaged to the channel;

FIG. 6 is a bottom perspective view of the top portion engaging the bottom portion of the container;

FIG. 7 is a top perspective view indicating how the top portion can slide onto and off the bottom portion an alternative embodiment of the container;

FIG. 8 is a top perspective view indicating how the top portion can slide onto the base portion for forming the selectively secured arrangement of an alternative embodiment of the container;

FIG. 9 is a top perspective view of an embodiment of the base portion of the container;

FIG. 10 is a top view of an embodiment of the base portion of the container;

FIG. 11 is a top perspective view of an embodiment of the base portion of the container; and

FIG. 12 is a top view of an embodiment of the base portion of the container.

### DETAILED DESCRIPTION OF THE INVENTION

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

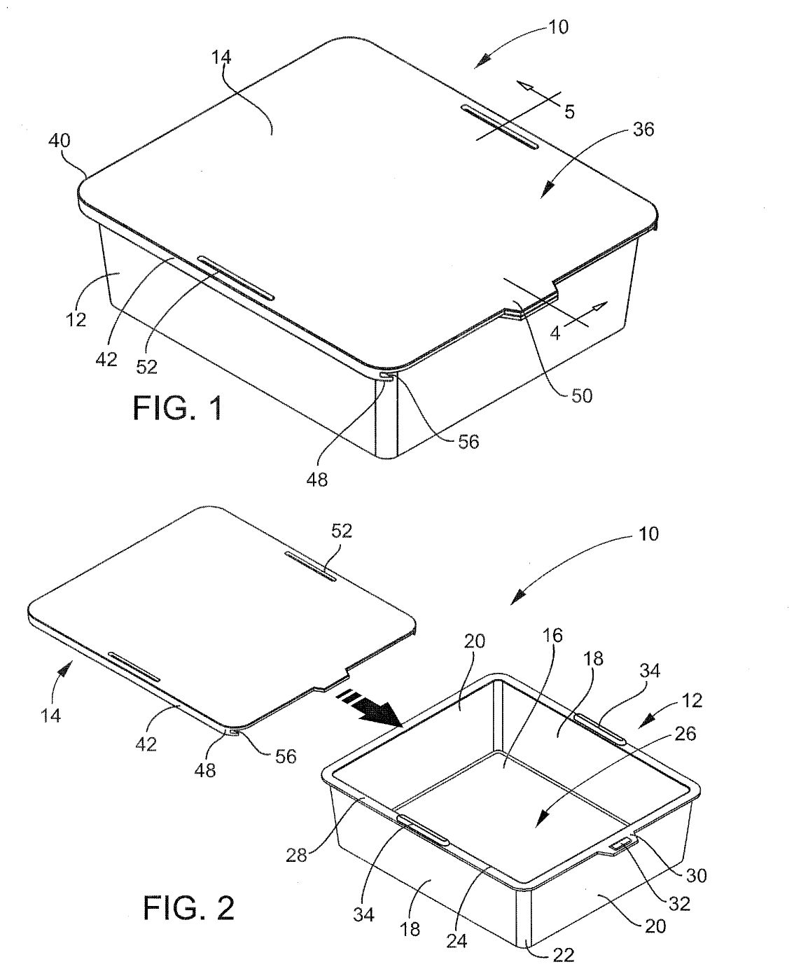

Referring now specifically to the drawings, a container is illustrated in FIGS. 1-6 and shown generally at reference numeral 10. The container 10 has a bottom portion 12 and a top portion 14. The bottom portion 12 includes a base portion 16 that extends to an outer edge. A first pair of opposed sidewalls 18 and a second pair of opposed sidewalls 20 extend upwardly from the outer edge of the base portion 16 and intersect at defined corners 22. Preferably, the corners 22 are rounded and do not contain sharp edges or end portions. The first pair of opposed sidewalls 18 and the second pair of opposed sidewalls 20 extend upwards to an upper edge 24. The base portion 16, first pair of opposed sidewalls 18 and second pair of opposed sidewalls 20 form a cavity 26 therein.

A lip 28 extends outwardly from the upper edge 26 of the bottom portion 12. The lip 28 has a top side and a bottom side. Preferably the lip 28 extends outwardly from the upper edge and away from the sidewalls (18,20) at about a 90° angle. The plane of the lip 28 is parallel to the plane of the base portion 16. In other words, the lip 28 is substantially perpendicular to the sidewalls (18,20) and parallel to the base portion 16. A portion of the lip 28 contains a tab portion 30 that extends outwardly from the lip 28 and has a length that is greater than the length of the lip 28. As illustrated in FIGS. 2, 3, and 6, the tab 30 of the bottom portion 12 has a top side, a bottom side, a front side, a left side and a right side. The front side is spaced away from the lip 28 and the left side and right side extend from the front side to the lip 28. Preferably, the left side and right side are angled outwards from either edge of the front side, wherein the length of the tab 30 at the intersection of the left side, right sight and front side is smaller than the length at the intersection of the left side, right side, and lip 26.

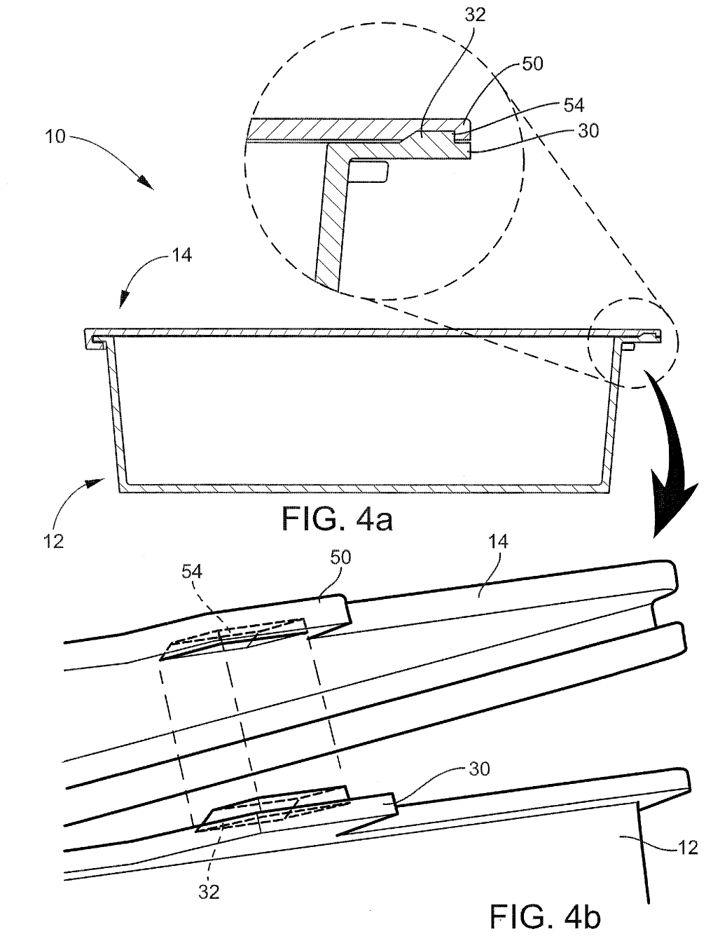

As illustrated in FIGS. 2, 3, 4a, 4b, and 6, the top side of the tab 30 contains a notch 32. The notch 32 extends upwardly from the top side of the tab 30 and is preferably disposed within the center portion of the top side of the tab 30. The notch 32 is received within a slot 54 disposed on the underside of the tab 50. As shown in FIGS. 4a and 4b, when the notch 32 is received within the slot 54, the top portion 14 is selectively secured to the bottom portion 12. Selectively secured means the top portion 14 is not integral or permanently attached to the bottom portion 12. Instead, the top portion 14 may be removed and separated from the bottom portion 14 by a user without much effort and without damaging either the top portion 14 or bottom portion 12. In other words, the top portion 14 can slide onto and off the bottom portion 12. The slot 54 has a shape that corresponds to the shape of the notch 32, allowing the notch 32 to fit within the slot 54.

As illustrated in FIGS. 2, 3, 4a, 4b, the notch 32 is generally square or rectangular. The notch 32 has a top portion and four sides extending downwardly from the top portion. Three of the four sides extend downwardly from the top portion, wherein the plane of three of the sides is perpendicular to the plane of the top portion. The fourth side is angled outward from the top portion. As shown in FIGS. 4a and 4b, the fourth side is the side closest or adjacent the cavity 26 and the fourth side extends from the top portion and outwards at an angle towards the cavity 26. As illustrated, the fourth side extends towards the cavity 26, but engages the tab 30 and doesn't extend beyond the tab 30.

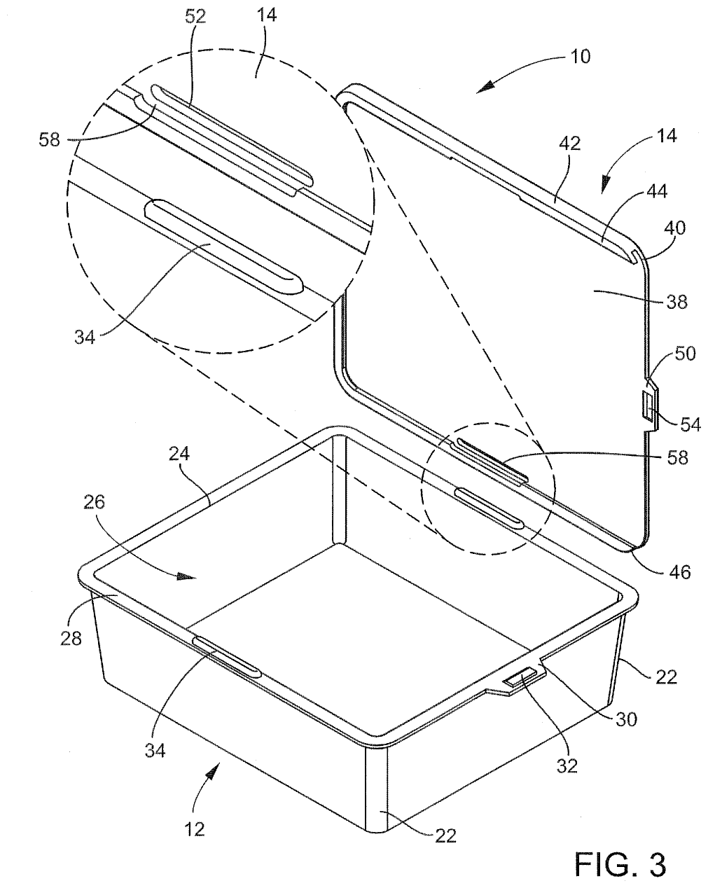

The top portion 14 contains a correspondingly shaped slot 54. As illustrated in FIGS. 3 and 4b, the slot 54 has four sides. Three of the sides extend downwardly from the bottom surface of the tab 50 of the top portion 14 to a base portion that is located within the tab 50 and does not extend to the top surface of the tab 50. The fourth side is angled towards the base portion of the slot 54 that corresponds the angle of the fourth side of the notch 32. In order to remove the slot 54 from the notch 32, the top portion 14 is lifted upwards and pushed backwards until the slot 54 has cleared the notch 32.

A rib 34 is disposed on the top side of the lip 28. The rib 34 is preferably centrally disposed in the central portion of the portion of the lip 28 that is engaged to a sidewall (18,20). As illustrated in FIGS. 2, 3, and 5, two ribs 34 are disposed on the lip 28, and specifically the ribs 34 are disposed on the portion of the lip 28 that are engaged to the first pair of opposed sidewalls 18. While two ribs 34 are shown, the container 10 may include only one rib 34, two or more ribs 34, or a plurality of ribs 34. As shown two ribs 34, comprising a first rib and a second rib, may be disposed on the portion of the lip 28 that is engaged to the second pair of opposed sidewalls 20. The rib 34 may be substantially rectangular or square shaped. The rib 34 has a height that is above the top side of the lip 28. The ribs 34 may be any shape, but as illustrated, the ribs 34 are generally rectangular. The ribs 34 extend a height above the top side of the lip 28.

The top portion 14 contains a top side 36 and a bottom side 38 and a first side, second side, third side, and fourth side, as shown in FIGS. 1, 2, 3 and 6. The top portion 14 extends to an outer edge 40. A skirt 42 extends downwardly from the outer edge 40 to a lower edge. Preferably, the skirt 42 extends perpendicularly downward from the outer edge 40. A flange 44 extends outwardly from the skirt 42 at the lower edge. The first end of the skirt 42 is engaged to the outer edge 40 and the second end of the skirt 42 is engaged to the flange 44. Preferably, the flange 44 extends outwardly from the skirt 42. A track 46 is formed between the bottom side 38 of the top portion 14, inner side of the skirt 42, and top side of the flange 44. The skirt 42 extends downwardly from the outer edge 40 on the second side, third side, and fourth side of the top portion 14. The first side does not contain a skirt 42 or flange 44. Instead, a tab 50 extends outwardly from the outer edge of the first side of the top portion 14. The intersection of the second side and the third side is preferably rounded without containing a point or right angle at the intersection. Instead, this intersection has a radius of curvature as the outer edge of the second side intersects with the outer edge of the third side. Likewise, the intersection of the third side and the fourth side is preferably rounded without containing a point or right angle at the intersection. Instead, this intersection has a radius of curvature as the outer edge of the third side intersects with the outer edge of the fourth side.

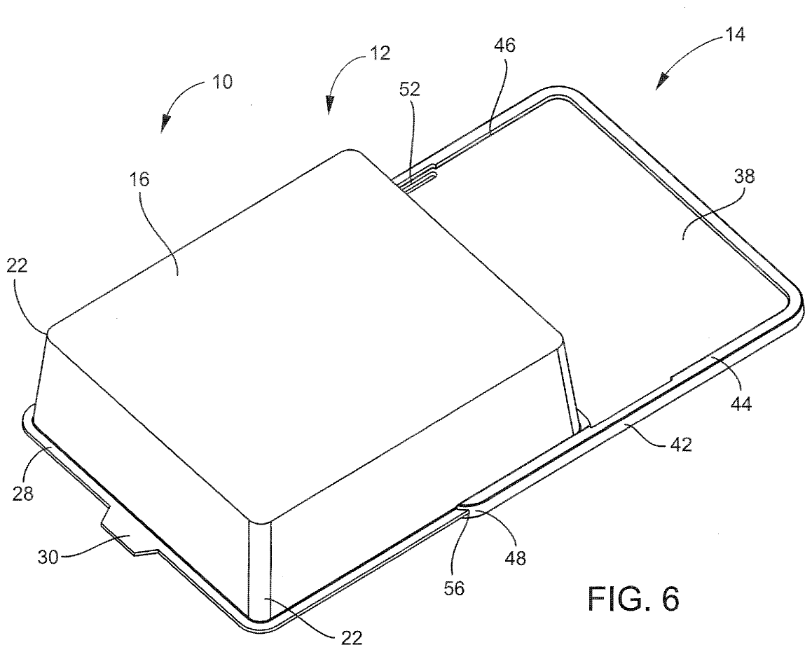

Much like the skirt 42, the flange 44 and track 46 are only contained on the second side, third side, and fourth side of the top portion 14, as shown in FIG. 6. Near the intersection of the first side and second side and first side and fourth side of the top portion 14 contains an annular portion 48 formed by the skirt 42 and flange 44. In other words, the skirt 42 and flange 44 have an annular shape at the annular portion 48. Additionally, the segment of the skirt 42 in the annular portion 48 contains a slit 56. The slit 56 is the opening to the track 46 disposed on the bottom side 38 of the second side, third side, and fourth side of the top portion 14.

During use, the top portion 14 is slid over the bottom portion 12 forming a selectively secured arrangement. In other words, the top portion 14 may slide onto and off the bottom portion 12 in a selectively secured arrangement. Prior to attaching the top portion 14, the first side of the top portion 14 is placed adjacent the backside of the bottom portion 12. The lip 28 of the bottom portion 12 is inserted into the slit 56 of the annular portion 48 and the top portion 14 is slid over the lip 28. As the top portion 14 is slide over the bottom portion 12, the lip is received within the track 46 of the top portion 14. In other words, the lip 28 above the first pair of opposed sidewalls is received within the track 46. Once the top portion 14 is entirely overtop the cavity 26 of the bottom portion 12, the lip 28 above one of the second pair of opposed sidewalls 20 is received within the track 46 disposed on the third side of the top portion 14, creating a stop and preventing the top portion 14 from proceeding further along the lip 28 of the bottom portion 12.

The top portion 14 contains a slot 54 that extends from the top side 36 to the bottom side 38 of the top portion 14 forming a cavity therein. When the top portion 14 slid over the bottom portion 12 and the slots 54 are overtop or above the ribs 34, the ribs 34 are received within the cavity of the slot 54, preventing further movement of the top portion 14, forming a selectively secured arrangement between the top portion 14 and bottom portion 12. The rib 34 has a first end and a second end, wherein the first end and the second end are curved or c-shaped. The slot 54 has a first end and a second end, wherein the first end and second end are also correspondingly cured or c-shaped to receive the first end and the second end of the rib 34. The rib 34 is retained within the slot 54 by friction fit.

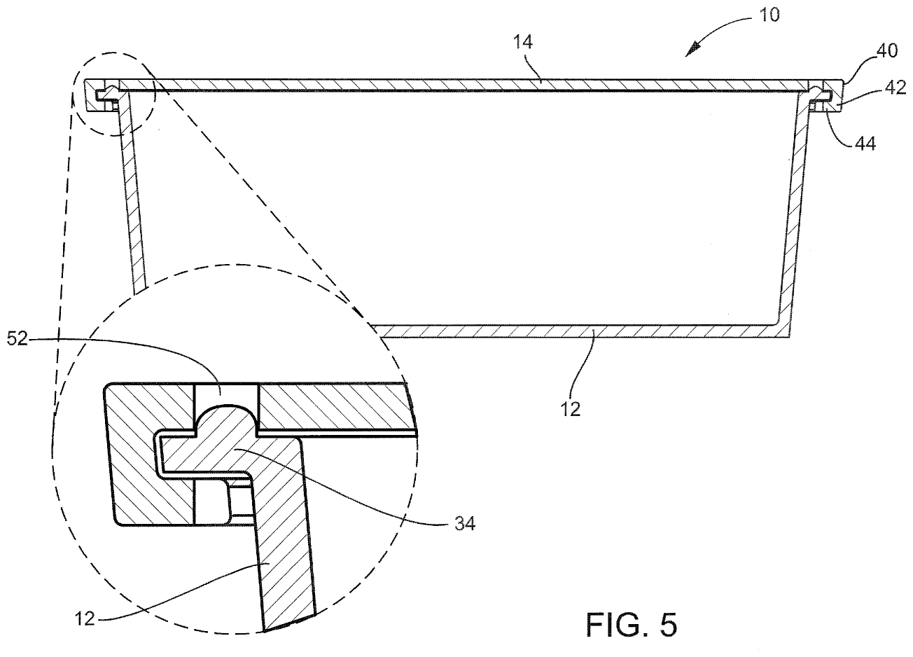

As shown in FIG. 3, the portion of the flange 44 adjacent the channel 52 has a reduced portion 58. The reduced portion 58 reduces the width of the flange 44 and the reduced portion 58 has a first end and a second end, wherein the first end and the second end extend downwards to a base portion. The base portion is disposed within the flange 44 and set-off from the outer edge of the flange 44. The first end and the second end extend from the outer edge of the flange 44, towards the skirt 42. The base portion of the reduced portion 58 extends within the flange 44, between the first end and the second end, and parallel to the skirt 42. The reduced portion 58 may have any length but may be at least the length of the channel 52, or preferably and as illustrated in FIGS. 3 and 5, a length that is less than the length of the channel 52. The reduced portion 58 is positioned on either side of the top portion 14.

The combination of the notch 32 and slot 54, and the rib 34 and channel 52 allow the top portion 14 to be selectively secured to the bottom portion 12. The removal of the notch 32 from the slot 54 and the ribs 34 from the channels 52 allow the top portion 14 to be separated from the bottom portion 12. The container 10 may have either the notch 32 and slot 54 or the rib 34 and channel 52, or both as illustrated. The top portion 14 is separated from the bottom portion 12 by sliding the top portion backwards, meaning away from the tab 30 of the bottom portion 12. Once the lip 28 has cleared the track 46, the top portion 14 is completely separated from the bottom portion 12. In other words, when the lip 28 has been completely removed from the track 46 of the top portion 14, the top portion 14 is completely separated from the bottom portion 12.

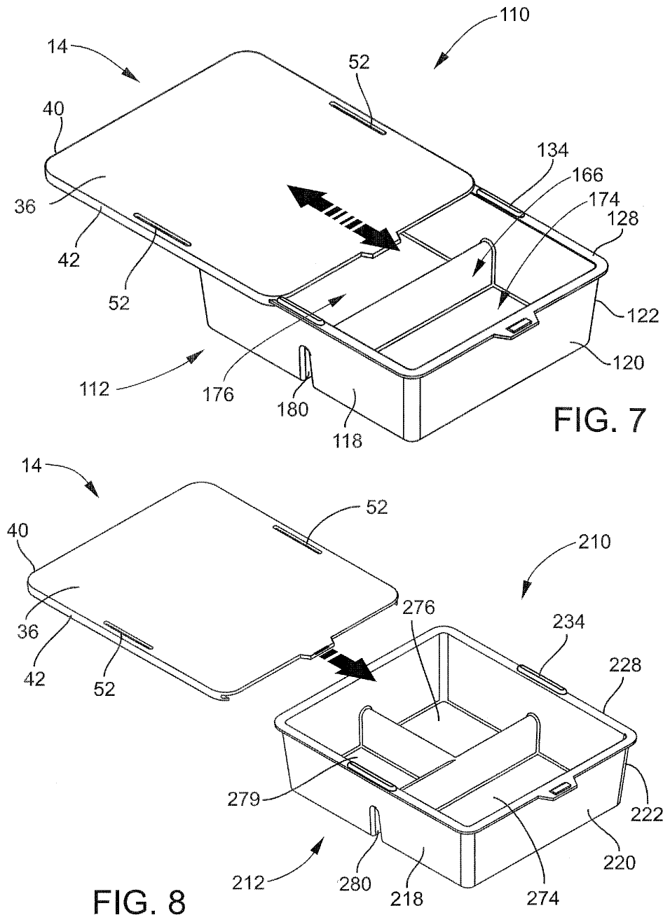

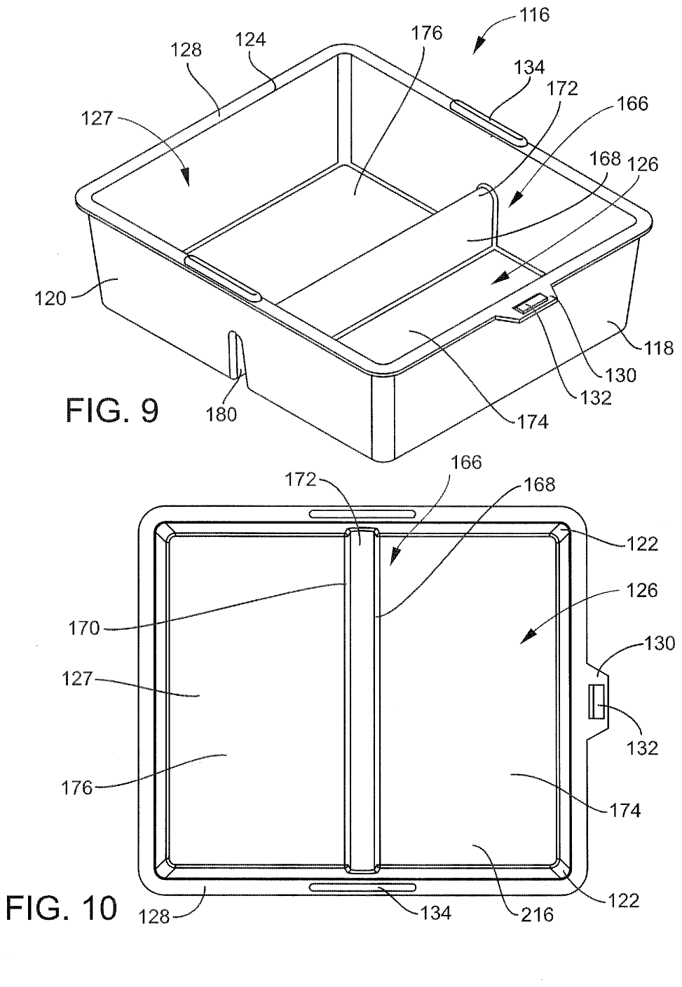

In another alternative embodiment of the bottom portion 112 as illustrated in FIGS. 7, 9, and 10, the bottom portion 112 may include a first compartment 174, a second compartment 176, a first cavity 126 and a second cavity 127. The first cavity 126 and second cavity 127 are separated from each other by a wall 166. The wall 166 has a first end and a second end. The first end is engaged to a sidewall and the second end is engaged to the opposed sidewall. As illustrated, the first end of the wall 166 is engaged to one of the first pair of opposed sidewalls 18 and the second end of the wall 166 is engaged to the opposite first pair of opposed sidewall 18. Alternatively, the first end of the wall 166 may be engaged to one of the second pair of opposed sidewalls 20 and the second end of the wall 166 is engaged to the opposite second pair of opposed sidewall 20.

An alternative embodiment of a bottom portion 112 of the container 110 is illustrated in FIGS. 7, 9 and 10. The alternative embodiment of the bottom portion 112 incorporates the same top portion 14, as described above and illustrated in FIGS. 1-6. The bottom portion 112 includes a wall 166 formed within the base portion 116 and respective pair of opposed sidewalls (118, 120). The wall 166 separates the first compartment 174 from the second compartment 176. The wall 166 is formed within the first pair of opposed sidewalls 118. The wall 166 has a first side 168 and a second side 170 connected by a top portion 172 that may be arcuate shaped. The first side 168 has a first end and a second end. The first end is engaged to the base portion 116 of the bottom portion 112 and extends upwardly to the second end that is engaged to the top portion 172. The second side 170 has a first end and a second end. The first end is engaged to the base portion 116 of the bottom portion 112 and extends upwardly to the second end that is engaged to the arcuate shaped top portion 172. The exterior surface of the first side 168, the second side 170, and the top portion 172 are disposed within the cavity 126 of the bottom portion 112. The interior surface of the first side 168 and the second side 170 are spaced apart and forms an opening 180 that extends from one sidewall 118 to the opposed sidewall 118.

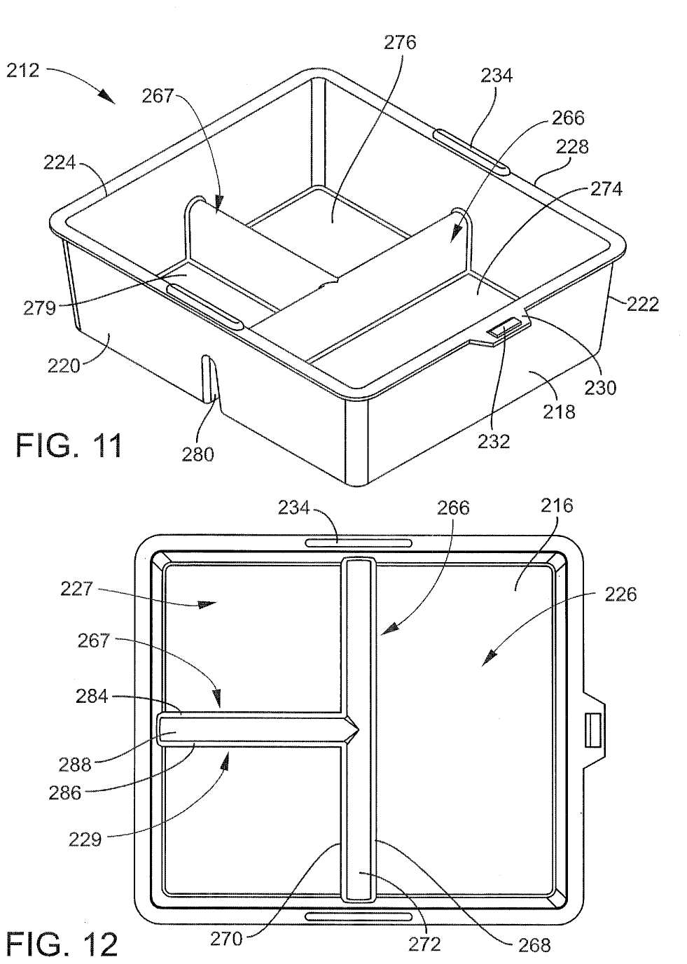

An alternative embodiment of a bottom portion 212 of the container 210 is illustrated in FIGS. 8, 11, and 12. This alternative embodiment of the bottom portion 212 incorporates the same top portion 14, as described above and illustrated in FIGS. 1-6. In this embodiment, the bottom portion 212 includes a first compartment 274, a second compartment 276, a third compartment 279, a first cavity 226, a second cavity 227, and a third cavity 229. The first cavity 226 is separated from the second cavity 227 and the third cavity 229 by a first wall 266. The first wall 266 has a first end and a second end. The first end is engaged to a sidewall and the second end is engaged to the opposed sidewall. As illustrated, the first end of the first wall 266 is engaged to one of the first pair of opposed sidewalls 218 and the second end of the first wall 266 is engaged to the opposite first pair of opposed sidewall 218. Alternatively, the first end of the first wall 266 may be engaged to one of the second pair of opposed sidewalls 220 and the second end of the first wall 266 is engaged to the opposite second pair of opposed sidewall 220.

As shown in FIGS. 8, 9, and 10, the first wall 266 is formed within the base portion 216 and respective pair of opposed sidewalls (218, 220). The first wall 266 separates the first compartment 274 from the second compartment 276. The first wall 266 is formed within the first pair of opposed sidewalls 218. The first wall 266 has a first side 268 and a second side 270 connected by a top portion 272 that may be arcuate shaped. The first side 268 has a first end and a second end. The first end is engaged to the base portion 216 of the bottom portion 212 and extends upwardly to the second end that is engaged to the top portion 272. The second side 270 has a first end and a second end. The first end is engaged to the base portion 216 of the bottom portion 212 and extends upwardly to the second end that is engaged to the arcuate shaped top portion 272. The exterior surface of the first side 268, the second side 270, and the top portion 272 are disposed within the cavities 226, 227, and 229 of the bottom portion 212. The interior surface of the first side 268 and the second side 270 are spaced apart and form an opening 280 that extends from one sidewall 218 to the opposed sidewall 218.

The second cavity 227 and the third cavity 229 are separated from each other by a second wall 267. The second wall 267 has a first end and a second end. The first end is engaged to a sidewall and the second end is engaged to the second side 270 of the first wall 266. As illustrated, the first end of the second wall 267 is engaged to one of the second pair of opposed sidewalls 220 and the second end of the second wall 267 is engaged to the second side 170 of the first wall 266. The exact location the first end and second end are engaged to the sidewall 220 and first wall 266 may vary depending upon the desired size of the second compartment 276 and the third compartment 279. The first end of the second wall 267 may be engaged at or near the center point of the sidewall 220 and the second end of the second wall 267 may be engaged at or near the center point of the second side 270 of the first wall 266, forming a second compartment 276 and a third compartment 279 that are the same or similar sizes. Alternatively, the first end of the first wall 266 may be engaged to one of the second pair of opposed sidewalls 220 and the second end of the first wall 266 is engaged to the opposite second pair of opposed sidewall 220. In this embodiment, the first end of the second wall 267 is engaged to one of the first pairs of opposed sidewall 2018 and the second end is engaged to the first wall 266.

The second wall 267 is formed within the base portion 216 and a sidewall (218, or alternatively 220 depending upon the embodiment). The second wall 267 separates the second compartment 276 from the third compartment 279. The second wall 267 is formed within a sidewall of the second pair of opposed sidewalls 220. The second wall 267 has a first side 284 and a second side 286 connected by a top portion 288 that may be arcuate shaped. The first side 284 has a first end and a second end. The first end is engaged to the base portion 216 of the bottom portion 212 and extends upwardly to the second end that is engaged to the top portion 288. The second side 286 has a first end and a second end. The first end is engaged to the base portion 216 of the bottom portion 212 and extends upwardly to the second end that is engaged to the arcuate shaped top portion 288. The exterior surface of the first side 284, the second side 286, and the top portion 288 are disposed within the bottom portion and below the lip 228 of the bottom portion 212. The interior surface of the first side 284 and the second side 286 are spaced apart and form an opening that extends from one sidewall 220 to the second side 270 of the first wall 266.

The container 10, including the embodiments 110 and 210, are composed of a biodegradable material. Preferably, the material is a pulp material, such as sugarcane bagasse.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention and are intended to be covered by the following claims.

What is claimed is:

1. A bio-degradable container, comprising:
a bottom portion;
a top portion;
a first tab having a top portion and a bottom portion, the first tab extends outwardly from the bottom portion and contains a notch on the top portion of the first tab; and
a second tab having a top portion and a bottom portion, the second tab extends outwardly from the top portion and contains a slot having a correspondingly similar shape to the notch of the first tab,
wherein the notch of the first tab is received within the slot of the second tab when the top portion is placed over the bottom portion forming a selectively secured arrangement between the bottom portion and the top portion.

2. The bio-degradable container according to claim 1, wherein the bottom portion contains a base portion, a first pair of opposed sidewalls and a second pair of opposed sidewalls that intersect each other, the first pair of opposed sidewalls and the second pair of opposed sidewalls extend upwards to an upper edge and a lip extends outwardly from the first pair of opposed sidewalls and the second pair of opposed sidewalls of the bottom portion.

3. The bio-degradable container according to claim 1, wherein the top portion contains a top side and a bottom side, the bottom side contains a track.

4. The bio-degradable container according to claim 1, wherein the bottom portion contains a base portion, a first pair of opposed sidewalls and a second pair of opposed sidewalls that intersect each other and form a cavity therein, the first pair of opposed sidewalls and the second pair of opposed sidewalls extend upwards to an upper edge and a lip extends outwardly from the first pair of opposed sidewalls and the second pair of opposed sidewalls of the bottom portion; and′
the top portion contains a top side and a bottom side, the bottom side contains a track for receiving the lip of the bottom portion for forming the selectively secured arrangement between the top portion and the bottom portion.

5. The bio-degradable container according to claim 1, wherein the container is composed of a pulp material.

6. The bio-degradable container according to claim 1, wherein the container is composed of sugarcane bagasse.

7. The bio-degradable container according to claim 1, wherein the notch has a top portion and four side portions.

8. A bio-degradable container, comprising:
a bottom portion;
a top portion having a top side and a bottom side;
at least one channel is disposed within the top portion;
at least one rib disposed on the bottom portion that is received within the channel of the top portion for forming a selectively secured arrangement between the bottom portion and the top portion.

9. The bio-degradable container according to claim 8, wherein the channel extends from the top side to the bottom side of the top portion.

10. The bio-degradable container according to claim 8, wherein the channel and the rib have corresponding shapes.

11. The bio-degradable container according to claim 8, further comprising at least one cavity within the bottom portion.

12. The bio-degradable container according to claim 8, further comprising two or more cavities within the bottom portion.

13. The bio-degradable container according to claim 8, further comprising a first tab having a top portion and a bottom portion, the first tab extends outwardly from the bottom portion and contains a notch on the top portion of the first tab; and
a second tab having a top portion and a bottom portion, the second tab extends outwardly from the top portion and contains a slot having a correspondingly similar shape to the notch of the first tab,
wherein the notch of the first tab is received within the slot of the second tab when the top portion is placed over the bottom portion

14. The bio-degradable container according to claim 8, wherein the container is composed of a pulp material.

15. A bio-degradable container, comprising:
a bottom portion;
a top portion having a top side and a bottom side;
a first tab having a top portion and a bottom portion, the first tab extends outwardly from the bottom portion and contains a notch on the top portion of the first tab;
a second tab having a top portion and a bottom portion, the second tab extends outwardly from the top portion and contains a slot having a correspondingly similar shape to the notch of the first tab;
at least one channel is disposed within the top portion;
at least one rib disposed on the bottom portion;
wherein the notch of the first tab is received within the slot of the second tab and the rib is received within the channel of the top portion for forming a selectively secured arrangement between the bottom portion and the top portion when the top portion is placed over the bottom portion.

16. The bio-degradable container according to claim 15, wherein the bottom portion contains at least one compartment.

17. The bio-degradable container according to claim 15, wherein the bottom portion contains at least two compartments.

18. The bio-degradable container according to claim 15, wherein the container is composed of a pulp material.

19. The bio-degradable container according to claim 15, wherein the container is composed of sugarcane bagasse.

20. The bio-degradable container according to claim 15, further comprising three compartments.
